(19) United States
(12) Patent Application Publication
(10) Pub. No.: US 2008/0052229 A1
(43) Pub. Date: Feb. 28, 2008

(54) Automated loan repayment system and method

(76) Inventors: Craig E. Sheinker, Woodcliff Lake, NJ (US); Woochae Chung, Fort Lee, NJ (US)

Correspondence Address: Gerald T. Bodner. Esq.;BODNER & O'ROURKE, LLP, Suite 108, 425 Broadhollow Road, Melville, NY, 11791, US

(21) Appl. No.: 11/827,022

(22) Filed: Jul. 10, 2007

Related U.S. Application Data
(60) Provisional application No. 60/830,069, filed on Jul. 11, 2006.

(51) Int. Cl. G06Q 40/00

(52) U.S. Cl. 705/40

(57) ABSTRACT

Systems and methods for automated loan repayment involve utilizing consumer payment authorization, clearing, and settlement systems to allow a merchant to reduce an outstanding loan amount. After a customer identifier (e.g., a credit, debit, smart, charge, payment, etc. card account number) is accepted as payment from the customer, information related to the payment is forwarded to a merchant processor. In one embodiment, the merchant processor acquires the information related to the payment, processes that information, and then forwards the credit card or debit card batch sales reports/invoices of funds collected by the merchant to the lender or a payment receiver for the lender. The lender may then debit funds from the merchant's bank account based upon a predetermined or computed amount as at least a portion of the outstanding loan amount owed by the merchant. In another embodiment, the merchant processor may forward at least a portion of the payment directly to the lender. The lender may then keep a predetermined or computed amount of funds and return another portion to the merchant.

### CROSS REFERENCE TO RELATED APPLICATION

This application is related to U.S. Provisional Application Ser. No. 60/830,069, filed on Jul. 11, 2006, and entitled “Automated Loan Repayment System and Method”, the disclosure of which is incorporated herein by reference and on which priority is hereby claimed.

### BACKGROUND OF THE INVENTION

1. Field of the Invention

This invention relates to systems and processes for automated repayment of a loan by a merchant borrower via fees levied through an entity that processes payment transactions for the merchant.

2. Description of the Prior Art

A conventional method of transacting a purchase of an item or service using a credit card or debit card from authorization to settlement is shown in FIGS. 1A and 1B. Referring initially to FIG. 1A, it will be seen that a purchase transaction (e.g., a credit card transaction) generally begins with a cardholder 10 providing a customer identifier (typically, a unique identifying account number such as that on a credit card such as a Visa or MasterCard card, a debit card, a smart card, a charge card such as an American Express card, etc.) to a merchant 20, as indicated by an arrow 12, for payment of goods and/or services purchased by the customer. The merchant can be any business that accepts such form of payment for the goods and/or services provided to customers by the business. The cardholder 10 might present the card to the merchant 20 in person, or the cardholder 10 might provide the card number to the merchant over the telephone or electronically by computer (e.g., via the World Wide Web, WWW). Also, the cardholder 10 might provide the card number to an entity acting on behalf of the merchant such as a WWW provider that sets up and maintains the merchant's Web page(s). However the customer identifier (e.g., card number) gets to the merchant or the merchant's agent, authorization must be obtained before the payment can be accepted and the purchase transaction completed.

Authorization, as shown in FIG. 1A, involves an authorization request going to a merchant processor 30, as indicated by an arrow 22. The request generally gets to the merchant processor 30 electronically by, for example, transmission through the telephone system and/or some other network (e.g., the Internet and/or an intranet). The merchant processor 30 (also known as an acquirer because it acquires merchant transactions) then routes the authorization request to a card issuer 50 via a network 40, as indicated by arrows 32 and 42. In some embodiments, the merchant processor 30 (300 in FIGS. 2, 3A, 4A, and 4B) is the bank of the merchant 20, and the card issuer 50 is the cardholder's bank. The routing generally is performed electronically in a manner mentioned above (i.e., via one or more public and/or private networks). The network 40 may be, for example, the VisaNet system. Other examples of the network 40 include debit card processing network systems (e.g., Cirrus), the American Express card network, and the Discover (Novus) card network. It may be possible to bypass the network 40 and send the authorization request directly from the merchant processor 30 to the card issuer 50. In some instances, the card issuer 50 also performs the function of acquiring merchant transactions (American Express is an example). Also, the merchant processor 30 and the card issuer 50 can be merged, and the authorization request will then go only to the merchant processor 30 which itself then can approve or disapprove the request because the merchant processor 30 and the card issuer 50 are now the same entity. In the case where the network 40 is used and the card issuer 50 and the merchant processor 30 are separate (organizationally and/or physically) entities, the card issuer 50 receives the authorization request via the network 40 and either approves or disapproves the request. An example of when the card issuer 50 may disapprove the authorization request is when the cardholder 10 has reached the maximum limit on the card or if the card number has been fraudulently obtained. Assuming the request is approved, the card issuer 50 sends approval of the authorization to the merchant processor 30 via the network 40, as indicated by arrows 44 and 34. The merchant processor 30 then passes on the authorization approval to the merchant, as indicated by an arrow 24. With the approval, the second part of the card transaction can now occur. This return path (i.e., arrows 44, 34, and 24) also can be accomplished by electronic transmission through one or more private and/or public network systems. In general, all of the arrows in FIGS. 1A, 1B, and 2 represent electronic transmissions, except possibly for arrows 12, 22, 24, 26, 52, and 54 which may involve other types of transmission such as physical delivery (e.g., a card handed over by the cardholder/customer 10) or post (e.g., a bill sent to the cardholder 10 via the U.S. Postal Service or other carrier) or by telephone.

Referring now to FIG. 1B, to complete the purchase transaction, the dollar amount of the customer's purchase is forwarded to the merchant processor 30 by the merchant 20, as indicated by an arrow 26. The merchant processor 30 pays the merchant 20 some amount less than the amount submitted to the merchant processor 30. The merchant processor 30 typically charges a fee, often referred to as a discount rate, for processing the purchase transaction. For example, the customer's purchase may have been $100, and with a discount rate of 1.9%, the merchant 20 is paid $98.10 (i.e., $100 less the 1.9% discount rate) by the merchant processor 30. The merchant processor 30 submits the entire amount of the customer's purchase to the card issuer 50 via the network 40, as indicated by arrows 36 and 46. Again, the network 40 may be eliminated, and the merchant processor and card issuer functions may be contained in one entity. In the case where the network 40 is included and the merchant processor and card issuer functions are separate, the card issuer 50, via the network 40, pays the merchant processor 30 some amount less than the amount submitted to the card issuer 50 by the merchant processor 30, as indicated by arrows 48 and 38. This reduced amount reflects another fee levied on the transaction by the card issuer 50, often referred to as an interchange fee. The interchange fee is often part of the discount rate. The merchant processor 30 then in turn pays the merchant 20 (e.g., by forwarding payment to a bank having an account maintained by the merchant 20) some amount less than the customer's original purchase amount, as indicated by an arrow 28. For example, with an original customer purchase of $100, and with an interchange fee of 1.4%, the merchant processor 30 is paid $98.60 (i.e., $100 less the 1.4% interchange fee) by the card issuer 50. This amount is further reduced by the merchant processor's fee. Thus, in this $100 original customer purchase example, the merchant 20 is paid $98.10 by the merchant processor 30, the merchant processor 30 makes $0.50, and the card issuer makes $1.40. Stated another way, the merchant 20 pays 1.9% for the ability to offer customers the convenience of paying by card, and that 1.9% fee or surcharge is allocated to the merchant processor 30 (0.5%) and the card issuer (1.4%) for providing the merchant 20 with that ability.

The card issuer 50 bills the customer or cardholder 10 for the full amount of the original purchase (e.g., $100), as shown by arrow 52, and the cardholder 10 is responsible for paying that amount, plus any interest and other fees, in full or in installment payments, as shown by arrow 54. Also, when the network 40 is used, both the merchant processor 30 and the card issuer 50 generally pay a fee to the provider of the network 40. For example, in the case of VisaNet, the merchant processor might pay $0.069 to VisaNet as a card service fee, and the card issuer 50 might pay VisaNet $0.059 as a card service and transaction fee. These payments by the merchant processor 30 and the card issuer 50 to the provider of the network 40 reduce the amount made off of the surcharge (e.g., 1.9%) imposed on the merchant 20.

FIG. 2 illustrates another method of transacting a purchase, as disclosed in U.S. Pat. No. 6,941,281, which issued to Barbara S. Johnson, the disclosure of which is incorporated herein by reference. In this particular transaction, a lender 60 makes a loan to the merchant 20, as indicated by an arrow 62. The merchant 20 then is required to pay back the full loan amount plus interest, and possibly fees. In other conventional methods, the merchant 20 typically pays the outstanding loan back in periodic installments (e.g., equal monthly payments over five years). The merchant 20 may make these payments to the lender 60 or to some other loan repayment receiver.

In the transaction methodology of the aforementioned Johnson patent shown in FIG. 2, the loan repayment receiver is identified as the lender 60. A purchase transaction occurs as indicated in FIG. 1B except that the final step where the merchant processor pays the merchant is altered. More particularly, the payment indicated by the arrow 28 is changed. The patented Johnson method involves a merchant processor 300 designed to pay a portion of what would normally go to the merchant 20 to the lender 60 as repayment of at least a portion of the merchant's outstanding loan amount, as indicated by an arrow 29. The lender 60 then receives that portion of the payment forwarded by the merchant processor 300 and applies it to the merchant's outstanding loan amount to reduce that outstanding loan amount. The merchant processor 300 thus pays the merchant 20 some amount less than what the merchant 20 would receive in the arrangement of FIG. 1B, as indicated by an arrow 27 in FIG. 2. For example, carrying on with the example introduced above with reference to FIGS. 1A and 1B, instead of paying $98.10 to the merchant 20 on a $100 original card purchase, the merchant processor 300 might send $88.10 to the merchant 20 and the other $10.00 to the lender 60.

Referring to FIG. 3A, the merchant processor 300 includes at least a processor 302, memory 304, an input/output (I/O) device 306, a merchant accounts database 308, and a bus 310 or other means for allowing these components to communicate, such as disclosed in the Johnson patent. The I/O module 306 allows the merchant processor 300 to communicate electronically with the other components (e.g., the merchant 20, the network 40, the card issuer 50, and the lender 60) in the card transaction processing system shown in the drawings. The processor 302 and the memory 304 cooperate with each other and with the other components of the merchant processor 300 to perform all of the functions described herein with respect to the present invention. In one embodiment, the merchant processor 300 executes appropriate software to perform the functions described herein, including those disclosed in the aforementioned Johnson patent. In an alternative embodiment, some or all of the functionality described herein can be accomplished with dedicated electronics hard-wired to perform the described functions. The merchant accounts database 308 can include information identifying all merchants 20 with which the merchant processor 300 is authorized to do business (e.g., at least a plurality of unique merchant code numbers), and it also can include information about which lender 60 is associated with each authorized merchant 20 and how (e.g., dollar amounts and frequency) payments are to be made to the lenders 60 by the merchant processor 300. The merchant processor 300 can be an appropriately programmed computer such as a mainframe, minicomputer, PC, or Macintosh computer, as disclosed in the Johnson patent, or it can include a plurality of such computers cooperating to perform the functions described herein. Similarly, the other components of the card transaction system (e.g., the merchant 20, the network 40, the card issuer 50, and the lender 60) may typically include one or more appropriately programmed computers for implementing the functionality described herein, such components being disclosed in the Johnson patent.

Referring to FIG. 3B, the merchant 20 typically includes at least one computer unit 312, such as a microprocessor and associated peripherals, that communicates over a bus 314 with a consumer data input device 316, a transaction data input device 318, memory 320, and an input/output (I/O) device 322. The consumer data input device 316 is located at the point-of-sale to a consumer of merchandise or services from the merchant. The device 316 can include a keyboard for use to enter a consumer's account number/identifier, or alternatively it can include a magnetic card reader for reading a magnetic stripe on a plastic card inserted into the reader. With such a magnetic stripe card, the stripe is encoded with the identifier (e.g., the customer's Visa credit card account number). When such a plastic card is used, the device 316 also may include a keyboard for entry of a personal identification number (PIN) for verifying against a code stored in or on the card. The transaction data input device 318 also is located at the point-of-sale, and it typically includes a keyboard or the like for use by, for example, a sales clerk to enter the dollar amount of the merchandise or service purchased by the customer and possibly other related information. The device 318 could include a cash register. In some embodiments, the devices 316 and 318 can share a single keyboard. The consumer and transaction data entered through the devices 316 and 318 may be temporarily stored in the memory 320. The memory 320 also may include merchant data along with software to direct operation of the computer 312. The merchant data typically will include at least a merchant code number to identify the merchant, and merchant data also may include information indicating the time or location of the sale and/or the sales clerk involved in the purchase transaction, for example. The merchant 20 may have more than one point-of-sale location and each such location can be equipped with consumer and transaction data input devices 316 and 318. Similarly, memory 320 and I/O devices 322 can be replicated at each point-of-sale location at the merchant 20. In one embodiment, only the devices 316 and 318 are replicated at the merchant 20 such that only one computer 312 is needed by each single merchant location. VeriFone Inc. of Redwood City, Calif., for example, provides such merchant-location equipment.

Referring now to both FIG. 3A and FIG. 3B, the merchant processor 300 and the merchant 20 can communicate through the I/O devices 306 and 322. These devices 306 and 322 can be modems, for example.

While only one merchant 20 and one lender 60 are shown in the drawings, it should be understood that in general a plurality of merchants 20 will interact with the merchant processor 300, and the merchant processor 300 could interact with one or more lenders 60, in accordance with the conventional design. The different merchants 20 generally will have varying outstanding loan amounts owed to one or more of the various lenders 60. The conventional design has been shown and described with reference to one merchant 20 and one lender 60 for simplicity and ease of understanding. Also, as stated previously, the merchant processor 300 and the card issuer 50 can be separate entities (as is generally the case with Visa card processing) or the same entity, or at least affiliated entities, (as is generally the case with American Express card processing).

### OBJECTS AND SUMMARY OF THE INVENTION

It is an object of the invention to provide an automated loan repayment system and method based on fees levied on payment transactions such as those involving unique identifying account numbers (e.g., credit, debit, charge, payment, smart, etc. card numbers).

The invention utilizes a merchant processor in the loan repayment process. The merchant processor may be, for example, a third party entity (i.e., an entity other than the borrower or the lender), the same entity as the lender, or an entity affiliated in some way with the lender. As an example, with some credit cards, the merchant processor can be a third party. As another example, with some cards such as the American Express charge card, the merchant processor can be the same as (or at least closely affiliated with) the lender. In general, a “merchant processor” is any entity that acquires merchant transactions such as a bank or other financial institution, or an organization dedicated to acquiring and processing merchant transactions. Acquiring merchant transactions generally means receiving payment information from a merchant or on behalf of a merchant, obtaining authorization for the payment from the card issuer, sending that authorization to the merchant, and then completing the transaction by paying the merchant, submitting the payment, and getting paid by the issuer. For this service, the merchant processor typically levies a fee on the merchant that is a percentage of the amount of the payment transaction. In general, the payment information forwarded to the merchant processor relates to a customer identifier submitted to the merchant as payment for some good(s) and/or service(s), and that identifier can be the account number associated with, for example, a debit card, a smart card, a credit card (e.g., a Visa or MasterCard card), a charge card (e.g., an American Express card), etc.

The invention relates to systems and methods for automated repayment of a loan made by a lender to a merchant. The systems and processes of the invention utilize consumer payment transactions with the merchant to allow the merchant to reduce the outstanding loan amount. Typically, a percentage of a consumer's payment to the merchant (e.g., by credit card) is used to pay down the merchant's outstanding loan. In one embodiment of the present invention, a merchant that has borrowed a loan amount from the lender accepts a customer-identifying account number (e.g., a credit, charge, payment, or debit card number) as payment from the customer and information related to the payment is forwarded to a merchant processor. Acceptance of this type of payment from the customer can be done, for example, at a merchant location (e.g., a retail establishment), over the telephone, or electronically via, for example, the World Wide Web by the merchant or on behalf of the merchant. The merchant processor then acquires the information related to the payment transaction, processes that information, and forwards the credit card or debit card batch sales reports/invoices of funds collected by the merchant to the lender. The lender may then debit funds from the merchant's bank account based upon a predetermined or computed amount as at least a portion of the outstanding loan amount owed by the merchant. In another embodiment, the merchant processor may forward at least a portion of the payment directly to the lender. The lender may then keep a predetermined or computed amount of funds and return another portion to the merchant.

Thus, in accordance with one form of the present invention, a method for automated repayment of an outstanding obligation made by a merchant to a lender, the merchant conducting electronically a transaction with a customer, the payment settlement of the transaction involving at least the merchant and a merchant processor, includes the steps of, at a merchant, accepting a customer identifier as payment from the customer and electronically forwarding information related to the payment to a merchant processor; at the merchant processor, acquiring the information related to the payment from the merchant, authorizing and settling the payment, and forwarding at least one of a batch sales report and batch invoice of funds collected by the merchant to at least one of the lender and a payment receiver for the lender; and at the at least one of the lender and the payment receiver for the lender, receiving the at least one of the batch sales report and batch invoice of funds collected by the merchant and forwarded by the merchant processor, withdrawing funds from an account at a bank of the merchant by debiting means and applying the funds to the outstanding obligation made by the merchant to the lender to reduce the obligation. Furthermore, at the least one of the lender and the payment receiver for the lender, the step of withdrawing funds from the account at the bank of the merchant may include the step of withdrawing the funds using an automatic clearing house (ACH) process. Additionally, the merchant processor may be a computerized merchant processor, and the payment receiver for the lender may be a computerized payment receiver. In addition, the accepting step may include the step of accepting at least one of a credit card number, a debit card number, a charge card number and a smart card number, as the customer identifier.

In accordance with another form of the present invention, a method for automated repayment of an outstanding obligation made by a merchant to a lender, the merchant conducting electronically a transaction with a customer, the payment settlement of the transaction involving at least the merchant, a merchant processor, and at least one of the lender and a payment receiver for the lender, may include the steps of, at the merchant, accepting a customer identifier as payment from the customer and electronically forwarding information related to the payment to the merchant processor; at the merchant processor, acquiring the information related to the payment from the merchant, authorizing the payment, and forwarding at least a portion of the payment to the at least one of the lender and the payment receiver for the lender; and at the at least one of lender and the payment receiver for the lender, receiving the at least a portion of the payment forwarded by the merchant processor, applying at least a portion of the at least a portion of the payment to the outstanding obligation made by the merchant to the lender to reduce the obligation, and forwarding to the merchant any funds not applied to the outstanding obligation. Furthermore, the merchant processor may be a computerized merchant processor, and the payment receiver for the lender may be a computerized payment receiver. Additionally, the accepting step may include the step of accepting at least one of a credit card number, a debit card number, a charge card number and a smart card number, as the customer identifier.

A system according to the invention automates repayment of a loan made by a lender to a merchant by utilizing payment transactions (e.g., credit, debit, charge, payment, smart, etc. card transactions) with the merchant. The system includes means for accepting a customer-identifing account number as payment from the customer and for forwarding information related to the payment to a merchant processor. In one embodiment, the merchant may use equipment provided by VeriFone Inc. of Redwood City, Calif., such as an electronic card swipe machine, to facilitate card transactions by customers. The merchant processor includes means for receiving the information related to the payment and means for forwarding a loan payment to the lender.

Thus, in accordance with one form of the present invention, a system for automated repayment of an outstanding obligation made by a merchant to a lender, the merchant conducting electronically a transaction with a customer, the payment settlement of the transaction involving at least the merchant and a merchant processor, includes, at the merchant, means for accepting a customer identifier as payment from the customer and for electronically forwarding information related to the payment to the merchant processor; at the merchant processor, means for receiving the information related to the payment from the merchant, means for authorizing and settling the payment, and means for forwarding at least one of a batch sales report and batch invoice of funds collected by the merchant to at least one of the lender and a payment receiver for the lender; and at the at least one of the lender and the payment receiver, means for receiving the at least one of the batch sales report and batch invoice of funds collected by the merchant and forwarded by the merchant processor, and means for withdrawing funds from an account at a bank of the merchant and for applying the funds to the outstanding obligation made by the merchant to the lender to reduce the obligation. The aforementioned “means” may include a computer, a processor, or the like at one or more of the lender or the lender's payment receiver, the merchant, and the merchant processor, and may include the internet, telephone, facsimile or other forms of telecommunications. Furthermore, the funds withdrawn from the account at the bank of the merchant may be withdrawn by using an automatic clearing house (ACH) process. Additionally, the merchant processor may be a computerized merchant processor, and the payment receiver for the lender, or the lender itself, may be a computerized payment receiver or a computerized lender, respectively. In addition, the accepting means may include means for accepting at least one of a credit card number, a debit card number, a charge card number and a smart card number, as the customer identifier.

In accordance with another form of the present invention, a system for automated repayment of an outstanding obligation made by a merchant to a lender, the merchant conducting electronically a transaction with a customer, the payment settlement of the transaction involving at least the merchant, a merchant processor, and at least one of the lender and a payment receiver for the lender, includes, at the merchant, means for accepting a customer identifier as payment from the customer and for electronically forwarding information relating to the payment to the merchant processor; at the merchant processor, means for receiving the information related to the payment from the merchant, means for authorizing the payment, means for forwarding at least a portion of the payment to the at least one of the lender and the payment receiver for the lender; and at the at least one of the lender and the payment receiver, means for receiving the at least a portion of the payment forwarded by the merchant processor, means for applying at least a portion of the at least a portion of the payment to the outstanding obligation made by the merchant to the lender to reduce the obligation, and means for forwarding to the merchant any funds not applied to the outstanding obligation. With this embodiment of the system, the aforementioned “means” may include the same or similar preferred forms as mentioned previously. Furthermore, the merchant processor may be a computerized merchant processor, and the payment receiver for the lender and the lender itself may be a computerized payment receiver and a computerized lender, respectively. Additionally, the accepting means may include means for accepting at least one of a credit card number, a debit card number, a charge card number and a smart card number, as the customer identifier.

The invention thus automates the loan repayment process, and provides an easy and efficient mechanism by which merchants that accept customer-identifying account numbers (e.g., credit cards) as payment for good(s) and/or service(s) can repay loans. The invention makes loan repayment and collection simple and efficient for both the borrower and the lender.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIGS. 1A and 1B are block diagrams illustrating a conventional payment transaction from authorization (FIG. 1A) to settlement (FIG. 1B).

FIG. 2 is a block diagram of a merchant processor making payment to both a merchant and a lender, in accordance with another conventional transaction method.

FIG. 3A is a diagram of a merchant processor system according to a conventional design which may be used in the system and method of the present invention.

FIG. 3B is a diagram of a conventional merchant location which may be used in the system and method of the present invention.

FIG. 4A is a block diagram of a merchant processor making payment to both a merchant and a lender, in accordance with the system and method of the invention.

FIG. 4B is a block diagram of a merchant processor making payment to both a merchant and a lender, in accordance with an alternative form of a system and method of the present invention.

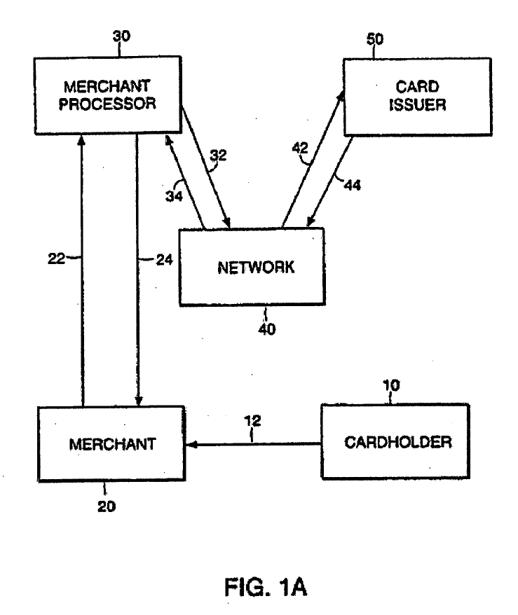

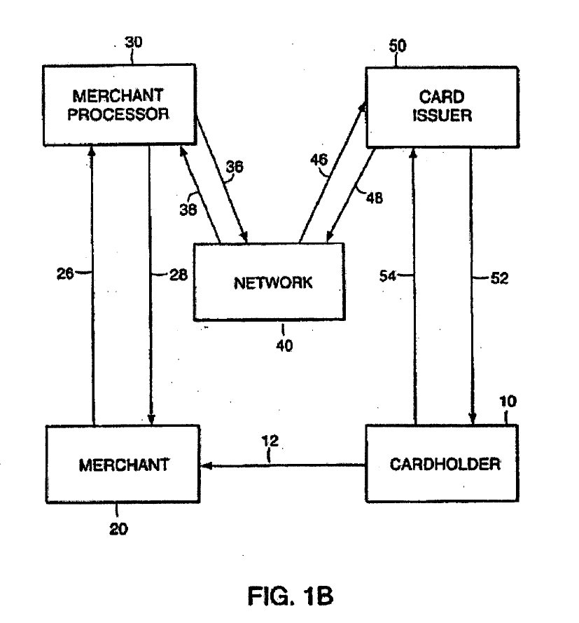

### DETAILED DESCRIPTION OF THE PREFERRED EMBODIMENTS

The invention differs from the conventional design with regard to the method of and system for repaying outstanding debts to the loan repayment receiver (e.g., lender) and the method of transferring funds from merchant to lender. In other respects, the system and method of the present invention is the same as or similar to the conventional system and method described previously and disclosed in the aforementioned U.S. Pat. No. 6,941,281 which issued to Barbara Johnson, the disclosures of which are incorporated herein by reference and are to be considered as part of the present invention.

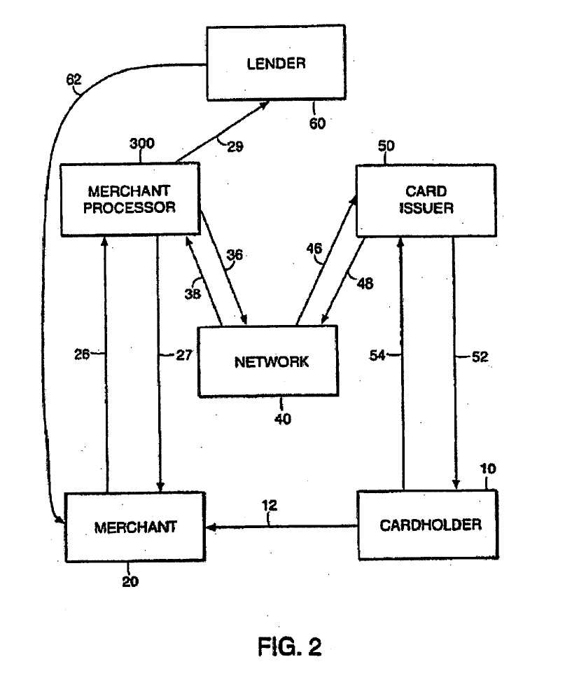

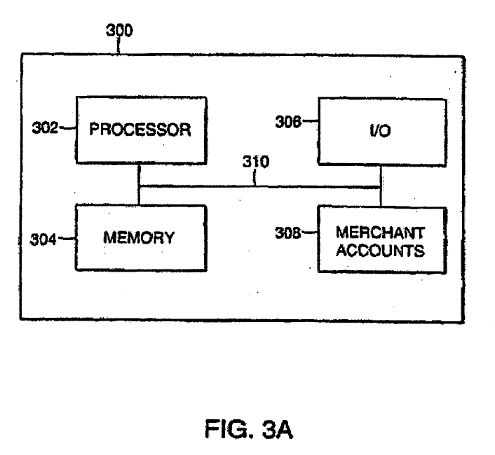

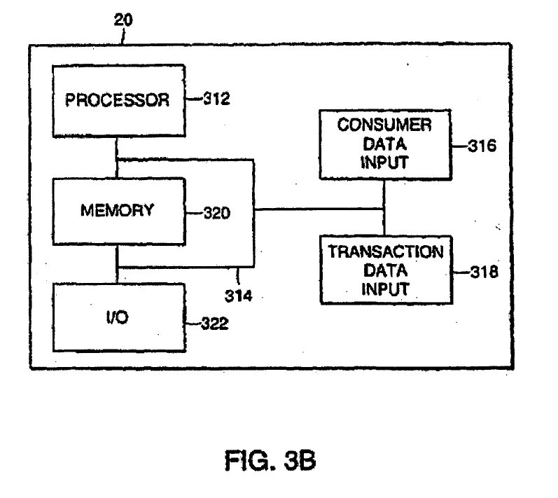

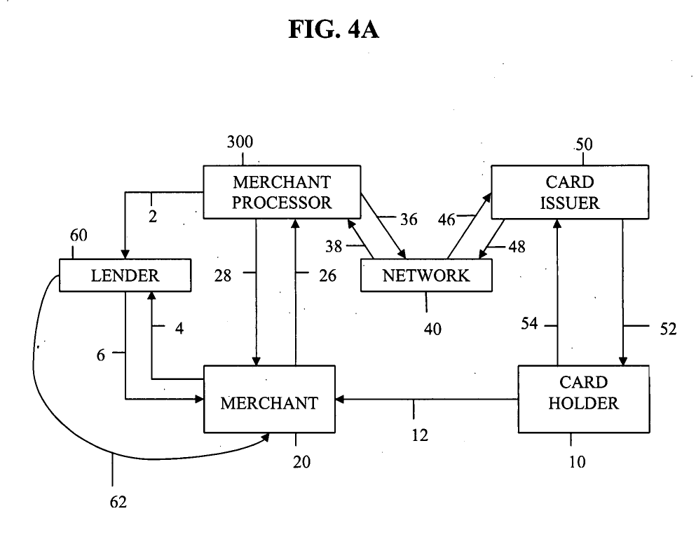

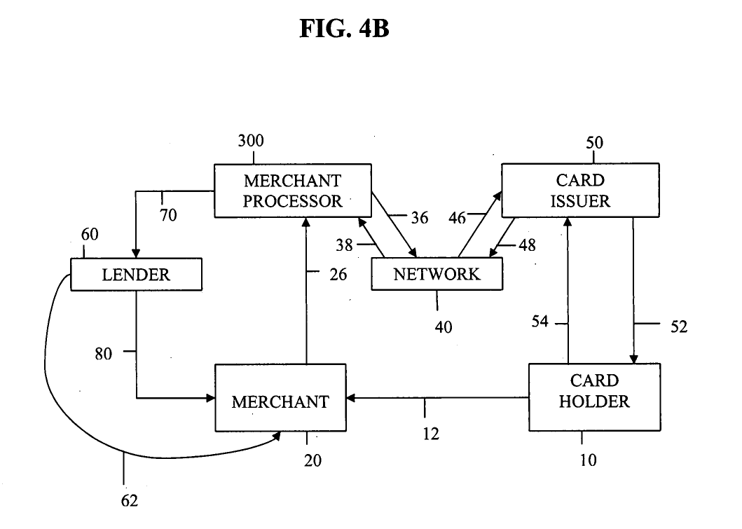

Referring to FIG. 4A, a lender 60 makes a loan to the merchant 20, as indicated by arrow 62. The merchant 20 is then required to pay back the full loan amount plus interest. The purchasing and approval transactions occur in the same fashion as in the conventional design (card holder 10, merchant 20, merchant processor 300, network 40, card issuer 50), described previously herein and in the aforementioned Johnson patent (U.S. Pat. No. 6,941,281). Thus, as shown in FIG. 4A, with respect to the settlement phase of the transaction, the dollar amount of the customer's purchase is forwarded to the merchant processor 300 by the merchant 20 as shown by arrow 26; the merchant processor 300 pays the merchant 20 the purchase amount less its fee or surcharge, as shown by arrow 28; the merchant processor 300 submits the entire amount of the customer's purchase to the card issuer 50 via the network 40, as shown by arrows 36 and 46; the card issuer 50, via the network 40, pays the merchant processor 300 the purchase price less its interchange fee, as shown by arrows 48 and 38; and as stated previously, the merchant processor 300 pays merchant 20, as shown by arrow 28. However, in the system and method of the present invention, the conventional design's method of repayment, illustrated in FIG. 2 by arrow 29, is altered.

Referencing FIG. 4A, merchant processor 300 receives funds from card issuer 50 through network 40, as shown by arrows 48 and 38. The entire portion of the funds returned to merchant processor 300 from card issuer 50 through network 40 as shown by arrows 48,36 is returned to merchant 20 (less any user fees of merchant processor 300) via arrow 28. Merchant processor 300 transmits credit card or debit card batch sales reports/invoices of funds collected by merchant 20 to lender 60 (or to lender's payment receiver), as shown by arrow 2, in accordance with an irrevocable instruction from the merchant 20 to the merchant processor 300 to provide this information to the lender 60. The entire batch report is preferably uploaded by software automatically at the lending institution, rather than entered manually. Lender 60 (or its payment receiver) evaluates the invoices sent by merchant processor 300 and computes the portion of funds owed to the lending institution based upon agreements between the entities. Loan servicing software is also preferably used to calculate automatically the amount the lender 60 should be paid by merchant 20 on the loan. The computed portion of funds owed the lender 60 may be based on a percentage of merchant's sales or may be a fixed amount. The percentage basis would be preferred by merchants 20 whose customers purchase their goods or services primarily by credit or debit cards because it provides a flexible method for paying back loans. Thus, if the merchant's sales are slow, the lender 20 (or its payment receiver) debits a lower amount from merchant's bank account. For merchants 20 whose customers make primarily cash purchases, the lender 60 and merchant 20 may agree to the lender making a fixed amount of withdrawal from the merchant's bank account (shown in FIG. 4A as being at merchant 20), regardless of the merchant's sales. Lender 60 (or its payment receiver acting on its behalf) is authorized to access the bank accounts of merchant 20 by agreement. Lender 60 (or the payment receiver) uses a form of debit withdrawal from the bank accounts of merchant 20 known as ACH (automatic clearing house). Lender 60 uses ACH on the accounts of merchant 20, as shown by arrow 6, at merchant's bank, and receives the previously computed amount of funds from merchant's bank, as shown by arrow 4. This process is repeated by agreement between the lending institution and merchant until all debts to lender 60 are repaid. It should be realized, of course, that lender 60 and the bank at which merchant 20 has its accounts may be the same entity.

A second method of repaying outstanding debt in accordance with the present invention is shown in FIG. 4B. With respect to FIG. 4B, and the alternative method and system of the present invention shown therein, it should be assumed that components and arrow transactions having the same reference numbers as those shown in FIG. 4A have the same structure and function as described previously, unless described herein with respect to the embodiment of the invention shown in FIG. 4B as being different. As illustrated by FIG. 4B, which shows the settlement phase of the transaction, the dollar amount of the customer's purchase is forwarded to the merchant processor 300 by the merchant 20, as shown by arrow 26; the merchant processor 300 submits the entire amount of the customer's purchase to the card issuer 50 via the network 40, as shown by arrows 36 and 46; and the card issuer 50, via the network 40, pays the merchant processor 300 the purchase price less its interchange fee, as shown by arrows 48 and 38. The entire portion of the funds returned to the merchant processor 300 by the card issuer 50 (less any merchant processor fees for its service) is provided to lender 60, as shown by arrow 70 and placed in an escrow account. The portion of the funds owed to lender 60 by merchant 20 is computed based upon an agreement between the entities and stored in the lending institution's (lender's) account. The remaining portion of the funds transferred to lender 60 from merchant processor 300 (the total returned funds minus the agreed to loan repayment percentage) is transferred by lender 60 to merchant 20, as shown by arrow 80. This process is repeated by agreement between the lending institution and merchant until all debts to the lender are repaid.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A method for automated repayment of an outstanding obligation made by
a merchant to a lender, the merchant conducting electronically a transaction with a customer, the payment settlement of the transaction involving at least the merchant and a merchant processor, which comprises the steps of:
at a merchant, accepting a customer identifier as payment from the customer and electronically forwarding information related to the payment to a merchant processor;
at the merchant processor, acquiring the information related to the payment from the merchant, authorizing and settling the payment, and forwarding at least one of a batch sales report and batch invoice of funds collected by the merchant to at least one of the lender and a payment receiver for the lender; and
at the at least one of the lender and the payment receiver for the lender, receiving the at least one of the batch sales report and batch invoice of funds collected by the merchant and forwarded by the merchant processor, withdrawing funds from an account at a bank of the merchant by debiting means and applying the funds to the outstanding obligation made by the merchant to the lender to reduce the obligation.

2. A method as defined by claim 1, wherein, at the least one of the lender and the payment receiver for the lender, the step of withdrawing funds from the account at the bank of the merchant includes the step of withdrawing the funds using an automatic clearing house (ACH) process.

3. A method as defined by claim 1, wherein the merchant processor is a computerized merchant processor, and wherein the at least one of the lender and the payment receiver for the lender is a computerized lender and a computerized payment receiver, respectively.

4. A method as defined by claim 1, wherein the accepting step comprises accepting at least one of a credit card number, a debit card number, a charge card number and a smart card number, as the customer identifier.

5. A system for automated repayment of an outstanding obligation made by a merchant to a lender, the merchant conducting electronically a transaction with a customer, the payment settlement of the transaction involving at least the merchant and a merchant processor, which comprises:
at the merchant, means for accepting a customer identifier as payment from the customer and for electronically forwarding information related to the payment to the merchant processor;
at the merchant processor, means for receiving the information related to the payment from the merchant, means for authorizing and settling the payment, and means for forwarding at least one of a batch sales report and batch invoice of funds collected by the merchant to at least one of the lender and a payment receiver for the lender; and
at the at least one of the lender and the payment receiver, means for receiving the at least one of the batch sales report and batch invoice of funds collected by the merchant and forwarded by the merchant processor, and means for withdrawing funds from an account at a bank of the merchant and for applying the funds to the outstanding obligation made by the merchant to the lender to reduce the obligation.

6. A system as defined by claim 5, wherein the funds withdrawn from the account at the bank of the merchant are withdrawn by using an automatic clearing house (ACH) process.

7. A system as defined by claim 5, wherein the merchant processor is a computerized merchant processor, and wherein the at least one of the lender and the payment receiver for the lender is a computerized lender and a computerized payment receiver, respectively.

8. A system as defined by claim 5, wherein the accepting means comprises means for accepting at least one of a credit card number, a debit card number, a charge card number and a smart card number, as the customer identifier.

9. A method for automated repayment of an outstanding obligation made by a merchant to a lender, the merchant conducting electronically a transaction with a customer, the payment settlement of the transaction involving at least the merchant, a merchant processor, and at least one of the lender and a payment receiver for the lender, which comprises the steps of:
at the merchant, accepting a customer identifier as payment from the customer and electronically forwarding information related to the payment to the merchant processor;
at the merchant processor, acquiring the information related to the payment from the merchant, authorizing the payment, and forwarding at least a portion of the payment to the at least one of the lender and the payment receiver for the lender; and
at the at least one of lender and the payment receiver for the lender, receiving the at least a portion of the payment forwarded by the merchant processor, applying at least a portion of the at least a portion of the payment to the outstanding obligation made by the merchant to the lender to reduce the obligation, and forwarding to the merchant any finds not applied to the outstanding obligation.

10. A method as defined by claim 9, wherein the merchant processor is a computerized merchant processor, and wherein the at least one of the lender and the payment receiver for the lender is a computerized lender and a computerized payment receiver, respectively.

11. A method as defined by claim 9, wherein the accepting step comprises accepting at least one of a credit card number, a debit card number, a charge card number and a smart card number, as the customer identifier.

12. A system for automated repayment of an outstanding obligation made by a merchant to a lender, the merchant conducting electronically a transaction with a customer, the payment settlement of the transaction involving at least the merchant, a merchant processor, and at least one of the lender and a payment receiver for the lender, which comprises:
at the merchant, means for accepting a customer identifier as payment from the customer and for electronically forwarding information relating to the payment to the merchant processor;
at the merchant processor, means for receiving the information related to the payment from the merchant, means for authorizing the payment, means for forwarding at least a portion of the payment to the at least one of the lender and the payment receiver for the lender; and
at the at least one of the lender and the payment receiver, means for receiving the at least a portion of the payment forwarded by the merchant processor, means for applying at least a portion of the at least a portion of the payment to the outstanding obligation made by the merchant to the lender to reduce the obligation, and means for forwarding to the merchant any funds not applied to the outstanding obligation.

13. A system as defined by claim 12, wherein the merchant processor is a computerized merchant processor, and wherein the at least one of the lender and the payment receiver for the lender is a computerized lender and a computerized payment receiver, respectively.

14. A system as defined by claim 12, wherein the accepting means comprises means for accepting at least one of a credit card number, a debit card number, a charge card number and
